(19) United States
(12) Patent Application Publication
(10) Pub. No.: US 2020/0247408 A1
(43) Pub. Date: Aug. 6, 2020

(54) INTER-VEHICLE DISTANCE CONTROLLER, SYSTEM INCLUDING THE SAME, AND METHOD THEREOF

(71) Applicants: Hyundai Motor Company, Seoul (KR); Kia Motors Corporation, Seoul (KR)

(72) Inventor: SeongWoong Lim, Hwaseong (KR)

(21) Appl. No.: 16/451,393

(22) Filed: Jun. 25, 2019

(30) Foreign Application Priority Data
Feb. 1, 2019 (KR) 10-2019-0013930

(51) Int. Cl. B60W 30/16; B60W 50/14; B60W 30/18

(52) U.S. Cl. CPC B60W 30/16; B60W 50/14; B60W 30/18072; B60W 2420/52; B60W 2554/802; B60W 2050/146; B60W 2520/10; B60W 2540/10; B60W 2554/804; B60W 2420/42

(57) ABSTRACT

An inter-vehicle distance controller, a system including the same, and a method thereof are provided. The inter-vehicle distance controller includes a processor that determines whether to enable an inter-vehicle distance control function, based on information in front of a host vehicle and driving information of the host vehicle. Whether to enable the inter-vehicle distance control function is determined by determining a user intent to accelerate the host vehicle or a user intent to use the inter-vehicle distance control function although the host vehicle is stopped. A storage stores the information in front of the host vehicle and the driving information of the host vehicle.

### CROSS-REFERENCE TO RELATED APPLICATION

This application is claims the benefit of priority to Korean Patent Application No. 10-2019-0013930, filed on Feb. 1, 2019, the entire contents of which are incorporated herein by reference.

### TECHNICAL FIELD

The present disclosure relates to an inter-vehicle distance controller, a system including the same, and a method thereof, and more particularly, to inter-vehicle control technologies of controlling to drive a host vehicle while maintaining a distance from a forward vehicle.

### BACKGROUND

For driver convenience, various functions, such as autonomous driving, for assisting the driver with operating a vehicle have been developed. For example, a smart cruise control (SCC) system maintains an inter-vehicle distance between a host vehicle and a forward vehicle constant. An operation interval of the SCC system is set for safe driving.

In other words, when a forward vehicle is detected and when an inter-vehicle distance control function switch is turned on by a user, an inter-vehicle distance control function (an SCC function) is enabled. However, when there is no forward vehicle, the inter-vehicle distance control function (the SCC function) is enabled based on a speed of a host vehicle. For example, when the host vehicle is stopped when no forward vehicle is present, due to a limit of a sensor to forward recognition performance (e.g., since object recognition performance is reduced when a relative speed is low), although the user turns on the inter-vehicle distance control function switch, the inter-vehicle distance control function (the SCC function) is not enabled.

Although the user intends to enable the inter-vehicle distance control function, when a vehicle speed of the host vehicle does not increase to greater than or equal to a predetermined reference value, the inter-vehicle distance control function remains disabled. Thus, after the user engages an accelerator pedal to increase a vehicle speed of the host vehicle and turns on the inter-vehicle distance control function switch, the inter-vehicle distance control function may be enabled. Therefore, user inconvenience is increased.

### SUMMARY

The present disclosure provides an inter-vehicle distance controller for expanding an interval where an inter-vehicle distance controller operates using information in front of a host vehicle and information regarding the host vehicle to enable an inter-vehicle distance control function in a state where the host vehicle is stopped without a forward vehicle, increasing user convenience, a system including the same, and a method thereof. The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an inter-vehicle distance controller may include: a processor configured to determine whether to enable an inter-vehicle distance control function, based on information in front of a host vehicle and driving information of the host vehicle. Whether to enable the inter-vehicle distance control function may be determined by determining a user intent to accelerate the host vehicle or a user intent to use the inter-vehicle distance control function although the host vehicle is stopped and a storage configured to store the information in front of the host vehicle and the driving information of the host vehicle.

In an exemplary embodiment, the processor may be configured to accelerate the host vehicle at a minimum setting speed of the inter-vehicle distance control function or a vehicle speed preset by the user, when the inter-vehicle distance control function is enabled. In addition, the processor may be configured to enable the inter-vehicle distance control function, when a forward vehicle is detected in front of the host vehicle and when no forward vehicle is detected in front of the host vehicle but a vehicle speed of the host vehicle is greater than or equal to a predetermined reference value.

Further, the processor may be configured to enter a free activation state of the inter-vehicle distance control function, when no forward vehicle is detected in front of the host vehicle and when a vehicle speed of the host vehicle is less than a predetermined reference value. The processor may also be configured to enter a stop hold mode for stopping the enablement of the inter-vehicle distance control function and determine the user intent to accelerate the host vehicle or to use the inter-vehicle distance control function, when in the free activation state of the inter-vehicle distance control function.

In an exemplary embodiment, the processor may be configured to determine the user intent to accelerate the host vehicle or the user intent to use the inter-vehicle distance control function, based on strength of an accelerator pedal of the host vehicle (e.g., an engagement amount of the pedal) and a vehicle speed of the host vehicle. In particular, the processor may be configured to determine the user intent to accelerate the host vehicle or the user intent to use the inter-vehicle distance control function, when the strength of the accelerator pedal is greater than or equal to a predetermined first reference value and when the vehicle speed of the host vehicle is greater than or equal to a predetermined second reference value.

The processor may be configured to enable the inter-vehicle distance control function, in response to determining the user intent to accelerate the host vehicle or to use the inter-vehicle distance control function. The processor may also be configured to maintain the stop hold mode, in response to determining that the user does not have the intent to accelerate the host vehicle or the intent to use the inter-vehicle distance control function.

According to another aspect of the present disclosure, a vehicle system may include: a sensing module configured to obtain information in front of a host vehicle and driving information of the host vehicle and an inter-vehicle distance controller configured to determine whether to enable an inter-vehicle distance control function, based on the information in front of the host vehicle and the driving information of the host vehicle. Whether to enable the inter-vehicle distance control function may be determined by determining a user intent to accelerate the host vehicle or a user intent to use the inter-vehicle distance control function although the host vehicle is stopped.

In an exemplary embodiment, the sensing module may include a radar configured to sense a location and speed of an object in front of the host vehicle and a camera configured to capture an image of the object in front of the host vehicle. The vehicle system may further include a display configured to display at least one or more of the driving information of the host vehicle, information regarding a forward vehicle in front of the host vehicle, information indicating whether to enable the inter-vehicle distance control function, and information regarding a vehicle speed set for inter-vehicle distance control when the inter-vehicle distance control function is enabled.

The inter-vehicle distance controller may be configured to enable the inter-vehicle distance control function, when a forward vehicle is detected in front of the host vehicle, enable the inter-vehicle distance control function, when no forward vehicle is detected in front of the host vehicle but a vehicle speed of the host vehicle is greater than or equal to a predetermined reference value, and enter a free activation state of the inter-vehicle distance control function, when no forward vehicle is detected in front of the host vehicle but the vehicle speed of the host vehicle is less than the predetermined reference value.

In addition, the inter-vehicle distance controller may be configured to display a minimum setting speed of the inter-vehicle distance control function or a vehicle speed preset by the user on the display, when in the free activation state of the inter-vehicle distance control function and enter a stop hold mode for stopping the enablement of the inter-vehicle distance control function. The inter-vehicle distance controller may be configured to determine the user intent to accelerate the host vehicle or to use the inter-vehicle distance control function, based on strength of an accelerator pedal of the host vehicle and a vehicle speed of the host vehicle, after entering the stop hold mode.

According to another aspect of the present disclosure, an inter-vehicle distance control method may include: obtaining information in front of a host vehicle and driving information of the host vehicle, and determining whether to enable an inter-vehicle distance control function, based on the information in front of the host vehicle and the driving information of the host vehicle. Whether to enable the inter-vehicle distance control function may be determined by determining a user intent to accelerate the host vehicle or a user intent to use the inter-vehicle distance control function although the host vehicle is stopped, and operating the host vehicle as a result of the determination whether to enable the inter-vehicle distance control function.

In an exemplary embodiment, the determining of whether to enable the inter-vehicle distance control function may include enabling the inter-vehicle distance control function, when a forward vehicle is detected in front of the host vehicle, enabling the inter-vehicle distance control function, when no forward vehicle is detected in front of the host vehicle but a vehicle speed of the host vehicle is greater than or equal to a predetermined reference value, and entering a free activation state of the inter-vehicle distance control function, when no forward vehicle is detected in front of the host vehicle but the vehicle speed of the host vehicle is less than the predetermined reference value.

In addition, the determining of whether to enable the inter-vehicle distance control function may further include displaying a minimum setting speed of the inter-vehicle distance control function or a vehicle speed preset by the user, when in the free activation state of the inter-vehicle distance control function, entering a stop hold mode for stopping the enablement of the inter-vehicle distance control function, and determining that the user has the intent to accelerate the host vehicle or the intent to use the inter-vehicle distance control function.

In an exemplary embodiment, the determining whether to enable the inter-vehicle distance control function may include enabling the inter-vehicle distance control function, in response to determining the user intent to accelerate the host vehicle or to use the inter-vehicle distance control function, and maintaining the stop hold mode, in response to determining that the user does not have the intent to accelerate the host vehicle or the intent to use the inter-vehicle distance control function. The operating of the host vehicle may include accelerating the host vehicle at the minimum setting speed of the inter-vehicle distance control function or the vehicle speed preset by the user.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a vehicle system including an inter-vehicle distance controller according to an exemplary embodiment of the present disclosure;

FIG. 2 is a flowchart illustrating a method for expanding an interval where an inter-vehicle distance controller operates, according to an exemplary embodiment of the present disclosure;

FIG. 3 is a drawing illustrating an exemplary operation of an inter-vehicle distance controller when a forward vehicle is present, according to an exemplary embodiment of the present disclosure;

FIG. 4 is a drawing illustrating an exemplary operation of an inter-vehicle distance controller when no forward vehicle is present, according to an exemplary embodiment of the present disclosure;

FIG. 5 is a drawing illustrating an exemplary operation where an inter-vehicle distance controller enters a free activation state of an inter-vehicle distance control function when no forward vehicle is present, according to an exemplary embodiment of the present disclosure; and

FIG. 6 is a block diagram illustrating a computing system according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

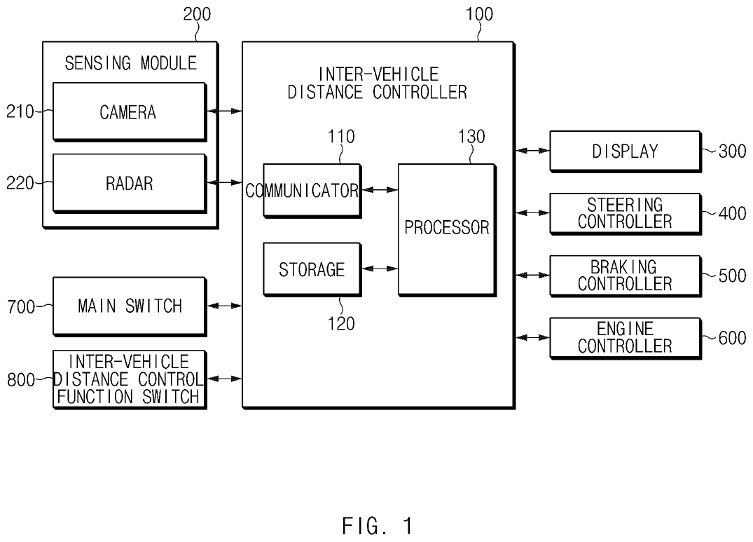

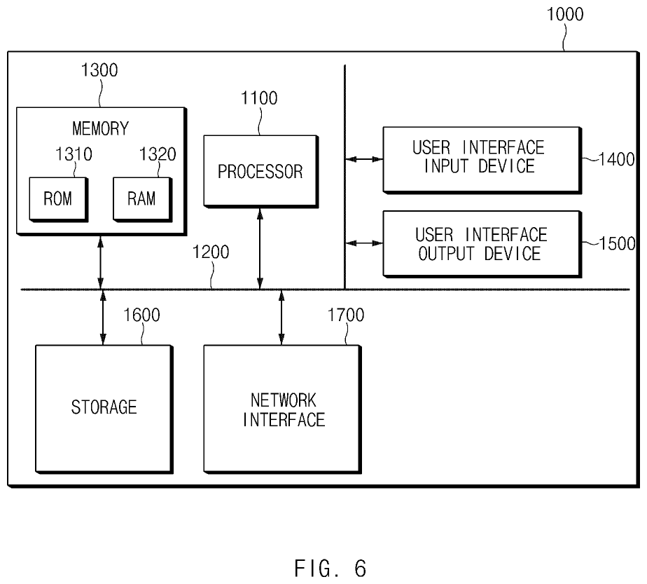

An exemplary embodiment of the present disclosure discloses technologies of expanding an interval where an inter-vehicle distance control function operates to increase convenience of a user. Hereinafter, a description will be given in detail of exemplary embodiments of the present disclosure with reference to FIGS. 1 and 6.

FIG. 1 is a block diagram illustrating a configuration of a vehicle system including an inter-vehicle distance controller according to an exemplary embodiment of the present disclosure. Referring to FIG. 1, the vehicle system according to an exemplary embodiment of the inventive concept may include an inter-vehicle distance controller 100, a sensing module 200, a display 300, a steering controller 400, a braking controller 500, an engine controller 600, a main switch 700, and an inter-vehicle distance control function switch 800.

The inter-vehicle distance controller 100 may be configured to determine whether to enable a vehicle control function based on information in front of a host vehicle (e.g., environment or surroundings in front of the host vehicle) and driving information of the host vehicle. Although the host vehicle is stopped, the inter-vehicle distance controller 100 may be configured to determine a user intent to accelerate the host vehicle or a user intent to use the vehicle control function to determine whether to enable the vehicle control function. In an exemplary embodiment of the present disclosure, the inter-vehicle distance controller 100 may include a smart cruise control (SCC) function for adjusting an inter-vehicle distance from a forward vehicle.

The inter-vehicle distance controller 100 may include a communicator 110, a storage 120, and a processor 130. The communicator 110 may be a hardware device implemented with various electronic circuits to transmit and receive a signal over a wireless or wired connection. In an exemplary embodiment of the present disclosure, the communicator 110 may be configured to perform inter-vehicle communication via controller area network (CAN) communication, local interconnect network (LIN) communication, or the like and may communicate with the sensing module 200, the display 300, the steering controller 400, the braking controller 500, the engine controller 600, or the like.

The storage 120 (e.g., memory) may be configured to store a sensing result of the sensing module 200 (e.g., information in front of the host vehicle, driving information of the host vehicle, or the like) and information regarding a user intent to accelerate the host vehicle or information regarding a user intent to use the vehicle control function, determined by the processor 130, or information indicating whether a vehicle distance control function is enabled. The storage 120 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The processor 130 may be electrically connected with the communicator 110 and the storage 120 and may electrically operate the respective components. The processor 130 may be an electrical circuit which executes instructions of software and may perform a variety of data processing and calculation described below. The processor 130 may expand an interval where the inter-vehicle distance control function operates, using switch information (e.g., on/off function of the main switch 700 or the inter-vehicle distance control function switch 800), information regarding a forward vehicle, driving information (e.g., a vehicle speed) of the host vehicle, or the like to enable the inter-vehicle distance control function when the host vehicle is stopped without the forward vehicle being present.

Furthermore, the processor 130 may prevent unintended acceleration which may occur due to an error operation of a driver when the inter-vehicle distance control function is enabled in the state where the host vehicle is stopped. The processor 130 may be configured to recognize information, such as a longitudinal relative location and speed of a forward vehicle, and driving information (e.g., a vehicle speed) of the host vehicle using the sensing module 200. The processor 130 may be configured to determine whether to enable or disable the inter-vehicle distance control function, based on switch information, information regarding a forward vehicle, and driving information of the host vehicle and determine whether the user has an intent to accelerate the host vehicle or an intent to use the inter-vehicle distance control function, using an input (e.g., strength of an accelerator pedal) and driving information (e.g., a vehicle speed) of the host vehicle.

Furthermore, the processor 130 may be configured to determine required deceleration and acceleration based on whether a forward vehicle is detected to operate the host vehicle. The processor 130 may be configured to execute a stop hold mode in response to determining the user intent to accelerate the host vehicle or the user intent to use the inter-distance control function. The stop hold mode may be a state where the inter-distance control function pauses and may refer to a free activation mode of the inter-vehicle distance control function. In particular, the inter-vehicle distance controller 100 may interwork with electronic stability control (ESC) to enter the stop hold mode. The ESC may refer to an electronic device configured to monitor an alignment of a vehicle or a flight vehicle which is traveling or flying in real time and adjust a braking device, an output, and the like when a critical situation occurs to help to correct the alignment of the vehicle or the flight vehicle.

Particularly, when the inter-vehicle distance control function is enabled, the processor 130 may be configured to accelerate the host vehicle at a minimum setting speed of the inter-vehicle distance control function or a vehicle speed preset by the user. When a forward vehicle is detected in front of the host vehicle, the processor 130 may enable the inter-vehicle distance control function. When no forward vehicle is detected in front of the host vehicle and when a vehicle speed of the host vehicle is greater than or equal to a predetermined reference value, the processor 130 may enable the inter-vehicle distance control function.

Additionally, when no forward vehicle is detected in front of the host vehicle and when the vehicle speed of the host vehicle is less than the predetermined reference value, the processor 130 may enter a free activation state of the inter-vehicle distance control function. When in the free activation state of the inter-vehicle distance control function, the processor 130 may enter the stop hold mode for stopping the enablement of the inter-vehicle distance control function and may be configured to determine whether the user has an intent to accelerate the host vehicle or an intent to use the inter-vehicle distance control function. The processor 130 may also be configured to determine whether the user has an intent to accelerate the host vehicle or an intent to use the inter-vehicle distance control function, based on strength of an accelerator pedal of the host vehicle (e.g., engagement amount of the pedal) or a vehicle speed of the host vehicle.

When the strength of the accelerator pedal is greater than or equal to a predetermined first reference value and when the vehicle speed of the host vehicle is greater than or equal to a predetermined second reference value, the processor 130 may be configured to determine that the user has the intent to accelerate the host vehicle or the intent to use the inter-vehicle distance control function. In response to determining that the user has the intent to accelerate the host vehicle or the intent to use the inter-vehicle distance control function, the processor 130 may enable the inter-vehicle distance control function.

When the strength of the accelerator pedal is less than the predetermined first reference value and when the vehicle speed of the host vehicle is less than the predetermined second reference value, the processor 130 may be configured to determine that the user does not have the intent to accelerate the host vehicle or the intent to use the inter-vehicle distance control function to maintain the stop hold mode. Thereafter, the processor 130 may count an internal counter. When the control of the ESC is maintained during time t1 (e.g., for about 5 minutes), due to a performance limit of the host vehicle, the processor 130 may engage with an electronic parking brake (EPB) and release the inter-vehicle distance control function (e.g., an SCC function). The sensing module 200 may be configured o sense a location of a forward vehicle, a speed of the forward vehicle, and the like and may include a camera 210, a radar 220, and the like.

In FIG. 1, an exemplary embodiment is exemplified as, but not limited to, only the camera 210 and the radar 220. For example, to obtain information such as a location of the forward vehicle, a speed of the forward vehicle, and a movement direction of the forward vehicle, the sensing module 200 may include an ultrasonic sensor. a laser scanner and/or a corner radar, a light detection and ranging (LiDAR), an acceleration sensor, a yaw rate sensor, a torque sensor and/or a wheel speed sensor, a steering angle sensor, or the like.

The display 300 may be operated by the inter-vehicle distance controller 100 and may be configured to display information indicating whether there is a forward vehicle present, driving information of the host vehicle, information regarding an inter-vehicle distance control situation, or the like on a screen. The display 300 may be implemented as a head-up display (HUD), a cluster, an audio video navigation (AVN), or the like. Furthermore, the display 300 may include at least one of a liquid crystal display (LCD), a thin film transistor-LCD (TFT-LCD), a light emitting diode (LED) display, an organic LED (OLED) display, an active matrix OLED (AMOLED) display, a flexible display, a bended display, and a three-dimensional (3D) display. Some thereof may be implemented as transparent displays configured as a transparent type or a semi-transparent type to see the outside. Moreover, the display 300 may be implemented as a touchscreen including a touch panel to be used as an input device other than an output device.

The steering controller 400 may be configured to adjust a steering angle of the vehicle and may include a steering wheel, an actuator interlocked with the steering wheel, and a controller configured to operate the actuator. The braking controller 500 may be configured to adjust braking of the vehicle and may include a controller configured to operate a brake. The engine controller 600 may be configured to drive an engine of the vehicle and may include a controller configured to adjust a speed of the vehicle.

When the main switch 700 is turned on by the user, starting of the vehicle may be turned on. When the main switch 700 is turned off by the user, the starting may be turned off. The inter-vehicle distance control switch 800 may be configured to turn the inter-vehicle distance control function on/off. In FIG. 1, an exemplary embodiment is exemplified with the main switch 700 and the inter-vehicle distance control function switch 800 provided separately. However, exemplary embodiments are not limited thereto. For example, the main switch 700 and the inter-vehicle distance control function switch 800 may be implemented as a one-touch switch into which the main switch 700 and the inter-vehicle distance control function switch 800 may be integrated. In other words, starting may be turned on/off as soon as the inter-vehicle distance control function is turned on/off, by one operation of the one-touch switch.

Accordingly, when the user turns on a main switch or inter-vehicle distance control function switch although the host vehicle is stopped without a forward vehicle being present, using information in front of the host vehicle, obtained using the radar and the camera, and driving information (e.g., a vehicle speed) of the host vehicle, an exemplary embodiment of the present disclosure may enable the inter-vehicle distance control function (e.g., the SCC function) to increase user convenience and prevent unintended acceleration capable of being generated due to an error operation of the user.

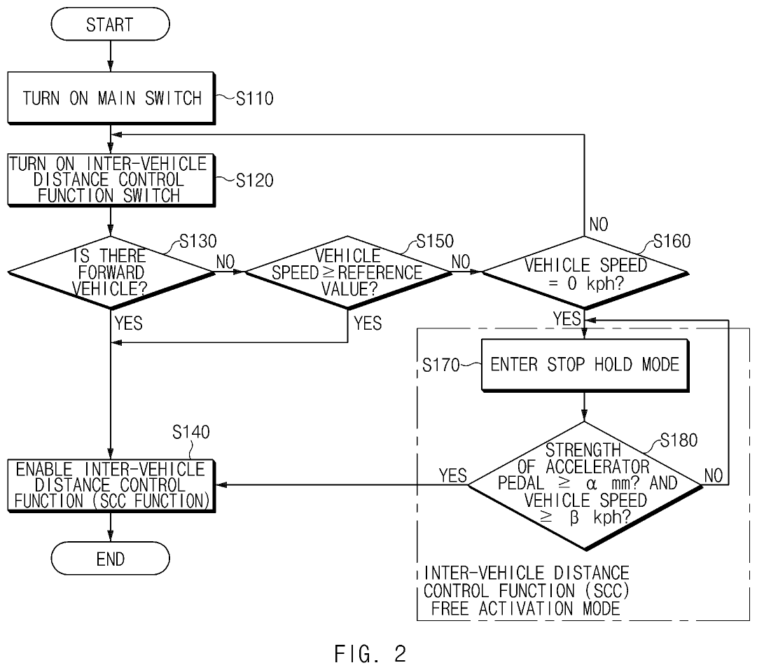

Hereinafter, a description will be given in detail of a method for expanding an interval where an inter-vehicle distance controller operates according to an exemplary embodiment of the present disclosure. FIG. 2 is a flowchart illustrating a method for expanding an interval where an inter-vehicle distance controller operates, according to an exemplary embodiment of the present disclosure. Hereinafter, it may be assumed that an inter-vehicle distance controller 100 of FIG. 1 performs a process of FIG. 2. Furthermore, in a description of FIG. 2, an operation described as being performed by an apparatus may be understood as being operated by a processor 130 of the inter-vehicle distance controller 100.

Referring to FIG. 2, when a main switch 700 of FIG. 1 (a starting switch) is turned on in S110 and when an inter-vehicle distance control function switch 800 is turned on in S120, in S130, an inter-vehicle distance controller 100 of FIG. 1 may be configured to determine whether a forward vehicle is present or detected in front of a host vehicle to determine whether to enable an inter-vehicle distance control function. In particular, the inter-vehicle distance controller 100 may be configured to detect a state where the host vehicle is traveling and whether there is an obstruction (e.g., a forward vehicle) in front of the host vehicle, per predetermined period of time using a sensing module 200 of FIG. 1.

In FIG. 2, an exemplary embodiment is exemplified as the main switch 700 and the inter-vehicle distance control function switch 800 being provided separately provided. However, exemplary embodiments are not limited thereto. For example, the main switch 700 and the inter-vehicle distance control function switch 800 may be implemented as a one-touch switch into which the main switch 700 and the inter-vehicle distance control function switch 800 may be integrated. When the one-touch switch is turned on, a switch for enabling an inter-vehicle distance control function may be turned on as soon as starting is turned on.

When the forward vehicle is detected in front of the host vehicle, in S140, the inter-vehicle distance controller 100 may enable the inter-vehicle distance control function irrespective of a vehicle speed of the host vehicle. In particular, the inter-vehicle distance controller 100 may be configured to accelerate the host vehicle at a minimum setting speed (e.g., about 30 kph) of the inter-distance control function or a speed (e.g., about 50 kph) set by a user. On the other hand, when no forward vehicle is detected in front of the host vehicle, in S150, the inter-vehicle distance controller 100 may be configured to determine whether a current vehicle speed of the host vehicle is greater than or equal to a predetermined reference value (e.g., about 10 kph).

When the current vehicle speed of the host vehicle is greater than or equal to the predetermined reference value, in S140, the inter-vehicle distance controller 100 may enable the inter-vehicle distance control function. On the other hand, when the current vehicle speed of the host vehicle is less than the predetermined reference value, in S160, the inter-vehicle distance controller 100 may be configured to determine whether the current vehicle speed is 0 kph.

When the current vehicle speed is 0 kph, in S170, the inter-vehicle distance controller 100 may enter a stop hold mode as a free activation state of the inter-vehicle distance control function. In particular, when the stop hold mode continues beyond a particular period of time t1, an electronic parking brake (EPB) may be engaged and the inter-vehicle distance control function may be released. In S180, the inter-vehicle distance controller 100 may be configured to determine whether strength of an accelerator pedal of the host vehicle is greater than or equal to a predetermined reference value α and whether a vehicle speed of the host vehicle is greater than or equal to a reference value β.

When the strength of the accelerator pedal is greater than or equal to the predetermined reference value α and when the vehicle speed of the host vehicle is greater than or equal to the reference value β, in S140, the inter-vehicle distance controller 100 may enable the inter-vehicle distance control function. In other words, when the strength of the accelerator pedal is greater than or equal to the predetermined reference value α and when the vehicle speed of the host vehicle is greater than or equal to the reference value β, the inter-vehicle distance controller 100 may be configured to determine that the user has an intent to accelerate the host vehicle and an intent to use the inter-vehicle distance control function to enable the inter-vehicle distance control function. In this case, α and β may be tuned to determine the intent of the user to accelerate the host vehicle and the intent of the user to use the inter-vehicle distance control function. For example, α may be tuned to greater than or equal to about 5 to 20, and β may be tuned to about 3 to 5.

Meanwhile, when the strength of the accelerator pedal is less than the predetermined reference value α or when the vehicle speed of the host vehicle is less than the reference value β, in S170, the inter-vehicle distance controller 100 may be configured to maintain the stop hold mode. Particularly, when the strength of the accelerator pedal is less than the predetermined reference value α or when the vehicle speed of the host vehicle is less than the reference value β, the inter-vehicle distance controller 100 may be configured to determine that the user does not have the intent to accelerate the host vehicle and the intent to use the inter-vehicle distance control function.

Since the existing inter-vehicle distance control system is not enabled when no forward vehicle is present, after a user separately engages an accelerator pedal to increase a vehicle speed to a speed capable of enabling the inter-vehicle distance control function, the inter-vehicle distance control function may be enabled. However, in an exemplary embodiment of the present disclosure, an interval where the inter-vehicle distance control function operates may be increased to enable the inter-vehicle distance control function in a state where the host vehicle is stopped without adding a separate sensor, increasing user convenience. An exemplary embodiment of the present disclosure may prevent unintended acceleration caused by the inter-vehicle distance control system, as the user unconsciously engages an accelerator pedal (e.g., performs an error operation), to increase safety.

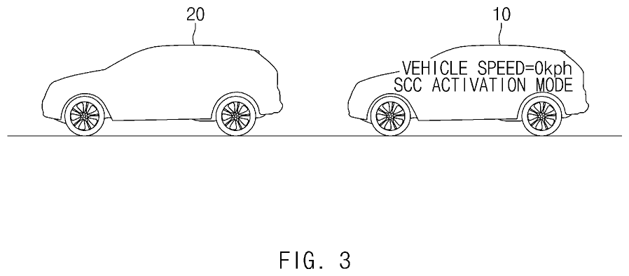

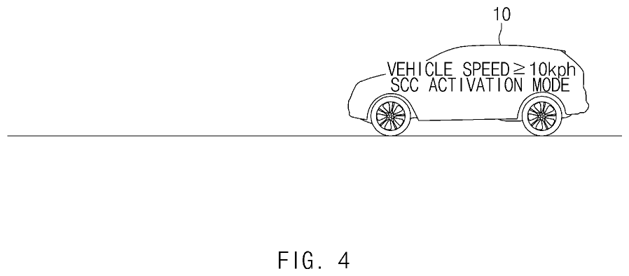

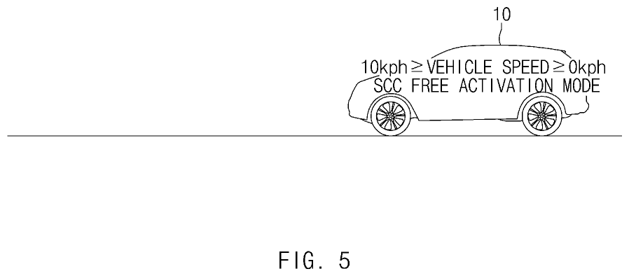

Furthermore, FIG. 3 is a drawing illustrating an exemplary operation of an inter-vehicle distance controller when there is a forward vehicle, according to an exemplary embodiment of the present disclosure. FIG. 4 is a drawing illustrating an exemplary operation of an inter-vehicle distance controller when there is no forward vehicle, according to an exemplary embodiment of the present disclosure. FIG. 5 is a drawing illustrating an exemplary operation where an inter-vehicle distance controller enters a free activation state of an inter-vehicle distance control function when there is no forward vehicle, according to an exemplary embodiment of the present disclosure.

Referring to FIG. 3, when a forward vehicle 20 is detected, although a vehicle speed of a host vehicle 10 is 0 kph, an inter-vehicle distance controller 100 enables an inter-vehicle distance control function. Referring to FIG. 4, when no the forward vehicle 20 is detected, the inter-vehicle distance controller 100 enables the inter-vehicle distance control function when the vehicle speed of the host vehicle is greater than or equal to a predetermined reference value (e.g., about 10 kph).

Referring to FIG. 5, when no the forward vehicle 20 is detected and when the vehicle speed of the host vehicle 10 is a value between 0 and the reference value (e.g., about 10 kph), the inter-vehicle distance controller 100 may enter an inter-vehicle distance control function (SCC) free activation state to enter an inter-vehicle distance control function activation mode (e.g., an SCC activation mode) or a stop hold mode based on strength of an accelerator pedal of the host vehicle 10 and a vehicle speed of the host vehicle 10.

FIG. 6 is a block diagram illustrating a computing system according to an exemplary embodiment of the present disclosure. Referring to FIG. 6, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory). Thus, the operations of the method or the algorithm described in connection with the exemplary embodiments disclosed herein may be embodied directly in hardware or a software module executed by the processor 1100, or in a combination thereof. The software module may reside on a storage medium (that is, the memory 1300 and/or the storage 1600) such as a RAM memory, a flash memory, a ROM memory, an EPROM memory, an EEPROM memory, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The present technology may expand an interval where an inter-vehicle distance controller operates using information regarding a forward vehicle and driving information of a host vehicle to operate the inter-vehicle distance controller in a state where the host vehicle is stopped without the forward vehicle being present, increasing user convenience. In addition, various effects directly or indirectly ascertained through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An inter-vehicle distance controller, comprising:
a processor configured to determine whether to enable an inter-vehicle distance control function, based on information in front of a host vehicle and driving information of the host vehicle, wherein whether to enable the inter-vehicle distance control function is determined by determining a user intent to accelerate the host vehicle or a user intent to use the inter-vehicle distance control function although the host vehicle is stopped; and
a storage configured to store the information in front of the host vehicle and the driving information of the host vehicle.

2. The inter-vehicle distance controller of claim 1, wherein the processor is configured to:
accelerate the host vehicle at a minimum setting speed of the inter-vehicle distance control function or a vehicle speed preset by the user, when the inter-vehicle distance control function is enabled.

3. The inter-vehicle distance controller of claim 1, wherein the processor is configured to:
enable the inter-vehicle distance control function, when a forward vehicle is detected in front of the host vehicle.

4. The inter-vehicle distance controller of claim 1, wherein the processor is configured to:
enable the inter-vehicle distance control function, when no forward vehicle is detected in front of the host vehicle and when a vehicle speed of the host vehicle is greater than or equal to a predetermined reference value.

5. The inter-vehicle distance controller of claim 1, wherein the processor is configured to:
enter a free activation state of the inter-vehicle distance control function, when no forward vehicle is detected in front of the host vehicle and when a vehicle speed of the host vehicle is less than a predetermined reference value.

6. The inter-vehicle distance controller of claim 5, wherein the processor is configured to:
enter a stop hold mode for stopping enablement of the inter-vehicle distance control function and determine the user intent to accelerate the host vehicle or the user intent to use the inter-vehicle distance control function, when in the free activation state of the inter-vehicle distance control function.

7. The inter-vehicle distance controller of claim 6, wherein the processor is configured to:
determine the user intent to accelerate the host vehicle or the user intent to use the inter-vehicle distance control function, based on strength of an accelerator pedal of the host vehicle and a vehicle speed of the host vehicle.

8. The inter-vehicle distance controller of claim 7, wherein the processor is configured to:
determine the user intent to accelerate the host vehicle or the user intent to use the inter-vehicle distance control function, when the strength of the accelerator pedal is greater than or equal to a predetermined first reference value and when the vehicle speed of the host vehicle is greater than or equal to a predetermined second reference value.

9. The inter-vehicle distance controller of claim 8, wherein the processor is configured to:
enable the inter-vehicle distance control function, in response to determining the user intent to accelerate the host vehicle or the user intent to use the inter-vehicle distance control function.

10. The inter-vehicle distance controller of claim 8, wherein the processor is configured to:
maintain the stop hold mode, in response to determining that the user does not have an intent to accelerate the host vehicle or an intent to use the inter-vehicle distance control function.

11. A vehicle system, comprising:
a sensing module configured to obtain information in front of a host vehicle and driving information of the host vehicle; and
an inter-vehicle distance controller configured to determine whether to enable an inter-vehicle distance control function, based on the information in front of the host vehicle and the driving information of the host vehicle,
wherein whether to enable the inter-vehicle distance control function is determined by determining a user intent to accelerate the host vehicle or a user intent to use the inter-vehicle distance control function although the host vehicle is stopped.

12. The vehicle system of claim 11, wherein the sensing module includes:
a radar configured to sense a location and speed of an object in front of the host vehicle; and
a camera configured to capture an image of the object in front of the host vehicle.

13. The vehicle system of claim 11, further comprising:
a display configured to display at least one or more of the driving information of the host vehicle, information regarding a forward vehicle in front of the host vehicle, information indicating whether to enable the inter-vehicle distance control function, and information regarding a vehicle speed set for inter-vehicle distance control when the inter-vehicle distance control function is enabled.

14. The vehicle system of claim 13, wherein the inter-vehicle distance controller is configured to:
enable the inter-vehicle distance control function, when a forward vehicle is detected in front of the host vehicle;
enable the inter-vehicle distance control function, when no forward vehicle is detected in front of the host vehicle and when a vehicle speed of the host vehicle is greater than or equal to a predetermined reference value; and
enter a free activation state of the inter-vehicle distance control function, when no forward vehicle is detected in front of the host vehicle and when the vehicle speed of the host vehicle is less than the predetermined reference value.

15. The vehicle system of claim 14, wherein the inter-vehicle distance controller is configured to:
display a minimum setting speed of the inter-vehicle distance control function or a vehicle speed preset by the user on the display, when in the free activation state of the inter-vehicle distance control function; and
enter a stop hold mode for stopping enablement of the inter-vehicle distance control function.

16. The vehicle system of claim 15, wherein the inter-vehicle distance controller is configured to:
determine the user intent to accelerate the host vehicle or the user intent to use the inter-vehicle distance control function, based on strength of an accelerator pedal of the host vehicle and a vehicle speed of the host vehicle, after entering the stop hold mode.

17. An inter-vehicle distance control method, comprising:
obtaining, by a controller, information in front of a host vehicle and driving information of the host vehicle; and
determining, by the controller, whether to enable an inter-vehicle distance control function, based on the information in front of the host vehicle and the driving information of the host vehicle, wherein whether to enable the inter-vehicle distance control function is determined by determining a user intent to accelerate the host vehicle or a user intent to use the inter-vehicle distance control function although the host vehicle is stopped; and
operating, by the controller, the host vehicle as a result of the determination whether to enable the inter-vehicle distance control function.

18. The inter-vehicle distance control method of claim 17, wherein the determining of whether to enable the inter-vehicle distance control function includes:
enabling, by the controller, the inter-vehicle distance control function, when a forward vehicle is detected in front of the host vehicle;
enabling, by the controller, the inter-vehicle distance control function, when no forward vehicle is detected in front of the host vehicle and when a vehicle speed of the host vehicle is greater than or equal to a predetermined reference value; and
entering, by the controller, a free activation state of the inter-vehicle distance control function, when no forward vehicle is detected in front of the host vehicle and when the vehicle speed of the host vehicle is less than the predetermined reference value.

19. The inter-vehicle distance control method of claim 18, wherein the determining of whether to enable the inter-vehicle distance control function further includes:
displaying, by the controller, a minimum setting speed of the inter-vehicle distance control function or a vehicle speed preset by the user, when in the free activation state of the inter-vehicle distance control function;
entering, by the controller, a stop hold mode for stopping enablement of the inter-vehicle distance control function; and
determining, by the controller, the user intent to accelerate the host vehicle or the user intent to use the inter-vehicle distance control function.

20. The inter-vehicle distance control method of claim 19, wherein the determining of whether to enable the inter-vehicle distance control function includes:
enabling, by the controller, the inter-vehicle distance control function, in response to determining the user intent to accelerate the host vehicle or the user intent to use the inter-vehicle distance control function; and
maintaining, by the controller, the stop hold mode, in response to determining that the user does not have an intent to accelerate the host vehicle or an intent to use the inter-vehicle distance control function.
